(19) United States
(12) Patent Application Publication
(10) Pub. No.: US 2020/0269238 A1
(43) Pub. Date: Aug. 27, 2020

(54) PROBES AND LIQUID HANDLING SYSTEMS AND METHODS INCLUDING THE SAME

(71) Applicant: PerkinElmer Health Sciences, Inc., Waltham, MA (US)

(72) Inventors: Michael DelVecchio, Stratford, CT (US); Anthony Chiappetta, Milford, CT (US)

(21) Appl. No.: 16/795,183

(22) Filed: Feb. 19, 2020

Related U.S. Application Data
(60) Provisional application No. 62/808,972, filed on Feb. 22, 2019.

(51) Int. Cl. B01L 3/00; B01F 13/10; B01F 13/00

(52) U.S. Cl. CPC B01L 3/502707; B01L 3/502715; B01L 3/5082; B01L 2300/0887; B01F 13/0059; B01L 2400/0409; B01L 2400/0487; B01F 13/1013

(57) ABSTRACT

A liquid handling system for use with a liquid sample in a container includes a probe and an actuator. The probe is configured to be inserted into the container to contact the liquid sample in the container. The probe has a probe axis. The probe includes an elongate probe body having a distal end, and an integral mixing device on the probe body proximate the distal end. The actuator is operable to reciprocate the probe in the container along the probe axis such that the mixing device generates mixing currents in the liquid sample.

### RELATED APPLICATION(S)

The present application claims the benefit of and priority from U.S. Provisional Patent Application No. 62/808,972, filed Feb. 22, 2019, the disclosure of which is incorporated herein by reference in its entirety.

### FIELD

The present application relates to liquid handling systems and, more particularly, to devices for mixing liquid samples.

### BACKGROUND

In liquid handling systems (e.g., in or associated with laboratory analytical devices) it is often necessary or desirable to mix a liquid sample disposed in a container such as a vial or tube. Powered mixers are sometimes used for this purpose. A powered mixer typically includes a shaft, a motor (e.g., electric motor), and an agitator mounted on a distal end of the shaft. The distal end of the shaft is inserted into the container and the shaft (and thereby the agitator) is rotated about the lengthwise axis of the shaft to mix liquid in the container.

### SUMMARY OF THE INVENTION

According to some embodiments, a liquid handling system for use with a liquid sample in a container includes a probe and an actuator. The probe is configured to be inserted into the container to contact the liquid sample in the container. The probe has a probe axis. The probe includes an elongate probe body having a distal end, and an integral mixing device on the probe body proximate the distal end. The actuator is operable to reciprocate the probe in the container along the probe axis such that the mixing device generates mixing currents in the liquid sample.

In some embodiments, the mixing device includes a mixing device body and at least one flow channel defined in the mixing device body. The reciprocation of the probe in the container along the probe axis generates a mixing current flow of the liquid sample through the at least one flow channel.

In some embodiments, the at least one flow channel includes a plurality of flow channels spaced circumferentially about the mixing device body.

In some embodiments, the flow channels are axially extending flow channels.

In some embodiments, the flow channels are helical flow channels.

In some embodiments, the mixing device has a rounded bottom surface.

According to some embodiments, the mixing device is bonded to the probe body.

In some embodiments, the mixing device is clamped onto the probe body.

According to some embodiments, the mixing device is mounted on the probe body such that reciprocation of the probe in the liquid sample causes the mixing device to rotate.

According to some embodiments, the probe body includes a probe lumen extending therethrough.

In some embodiments, the probe body includes a distal end port at the distal end and fluidly communicating with the probe lumen.

In some embodiments, the probe body includes a tip section that extends between a lower end of the mixing device and the distal end port.

According to some embodiments, the liquid handling system includes a liquid transfer actuator fluidly connected to the probe lumen and operable to withdraw fluid from the container through the probe lumen and/or to dispense fluid into the container through the probe lumen.

According to some embodiments, a method for mixing a liquid sample in a container in a liquid handling system includes inserting a probe into the container and into contact with the liquid sample in the container. The probe has a probe axis. The probe includes an elongate probe body having a distal end, and an integral mixing device on the probe body proximate the distal end. The method further includes reciprocating the probe in the container along the probe axis using an actuator such that the mixing device generates mixing currents in the liquid sample.

According to some embodiments, a probe for use in a liquid handling system for use with a liquid sample in a container has a probe axis. The probe includes an elongate probe body having a distal end, a probe lumen extending through the probe body, and an integral mixing device on the probe body proximate the distal end.

In some embodiments, the mixing device includes a mixing device body and at least one flow channel defined in the mixing device body. The probe is configured such that the mixing device generates a mixing current flow of the liquid sample through the at least one flow channel when the probe is reciprocated in the container along the probe axis.

In some embodiments, the at least one flow channel includes a plurality of flow channels spaced circumferentially about the mixing device body.

In some embodiments, the flow channels are axially extending flow channels.

In some embodiments, the flow channels are helical flow channels.

In some embodiments, the mixing device has a rounded bottom surface.

According to some embodiments, the mixing device is bonded to the probe body.

According to some embodiments, the mixing device is clamped onto the probe body.

According to some embodiments, the mixing device is mounted on the probe body such that reciprocation of the probe in the liquid sample causes the mixing device to rotate.

In some embodiments, the probe body includes a distal end port at the distal end and fluidly communicating with the probe lumen.

In some embodiments, the probe body includes a tip section that extends between a lower end of the mixing device and the distal end port.

According to some embodiments, a liquid handling system for use with a liquid sample in a container includes a probe and an actuator. The probe is configured to be inserted into the container to contact the liquid sample in the container. The probe has a probe axis. The probe includes an elongate probe body having a distal end, a probe lumen extending through the probe body, and an integral mixing device on the probe body proximate the distal end. The actuator is operable to displace the probe in the container such that the mixing device generates mixing currents in the liquid sample.

In some embodiments, the mixing device includes a mixing device body and at least one flow channel defined in the mixing device body. The actuator is operable to reciprocate the probe in the container along the probe axis. The probe is configured such that the mixing device generates a mixing current flow of the liquid sample through the at least one flow channel when the probe is reciprocated in the container along the probe axis.

In some embodiments, the at least one flow channel includes a plurality of flow channels spaced circumferentially about the mixing device body.

In some embodiments, the flow channels are axially extending flow channels.

In some embodiments, the flow channels are helical flow channels.

In some embodiments, the mixing device has a rounded bottom surface.

According to some embodiments, the mixing device is bonded to the probe body.

According to some embodiments, the mixing device is clamped onto the probe body.

In some embodiments, the mixing device is mounted on the probe body such that reciprocation of the probe in the liquid sample causes the mixing device to rotate.

In some embodiments, the probe body includes a distal end port at the distal end and fluidly communicating with the probe lumen.

According to some embodiments, the probe body includes a tip section that extends between a lower end of the mixing device and the distal end port.

According to some embodiments, the liquid handling system includes a liquid transfer actuator fluidly connected to the probe lumen and operable to withdraw fluid from the container through the probe lumen and/or to dispense fluid into the container through the probe lumen.

In some embodiments, the liquid handling system includes a spin actuator operable to forcibly spin the mixing device about the probe axis.

According to some embodiments, a method for mixing a liquid sample in a container in a liquid handling system includes inserting a probe into the container and into contact with the liquid sample in the container. The probe has a probe axis. The probe includes an elongate probe body having a distal end, a probe lumen extending through the probe body, and an integral mixing device on the probe body proximate the distal end. The method further includes displacing the probe in the container using an actuator such that the mixing device generates mixing currents in the liquid sample.

In some embodiments, the method includes withdrawing the liquid sample from the container through the probe lumen.

In some embodiments, the method includes dispensing the liquid sample or another liquid into the container through the probe lumen.

### BRIEF DESCRIPTION OF THE DRAWINGS

FIG. 1 is a schematic, perspective view of a liquid handling system including a probe according to some embodiments.

FIG. 2 is an exploded, perspective view of the probe of FIG. 1.

FIG. 3 is an enlarged, fragmentary, perspective view of the probe of FIG. 1.

FIG. 4 is a bottom view of the probe of FIG. 1.

FIGS. 5 and 6 are fragmentary, cross-sectional views of the liquid handling system of FIG. 1, illustrating use of the probe to mix a liquid sample in a container.

FIG. 7 is an enlarged, fragmentary, perspective view of a probe according to further embodiments.

FIG. 8 is an exploded, fragmentary, perspective view of the probe of FIG. 7.

FIG. 9 is a bottom view of the probe of FIG. 7.

FIG. 10 is a fragmentary, cross-sectional view of the probe of FIG. 7 being used to mix a liquid sample in a container.

FIG. 11 is an enlarged, fragmentary, perspective view of a probe according to further embodiments.

FIG. 12 is an exploded, fragmentary, perspective view of the probe of FIG. 11.

FIG. 13 is a bottom view of the probe of FIG. 11.

FIG. 14 is a fragmentary, cross-sectional view of the probe of FIG. 11 being used to mix a liquid sample in a container.

FIG. 15 is an enlarged, fragmentary, perspective view of a probe according to further embodiments.

FIG. 16 is a schematic, fragmentary, perspective view of a liquid handling system including a probe according to further embodiments.

### DETAILED DESCRIPTION

The present technology now will be described more fully hereinafter with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

Embodiments of the technology are directed to apparatus for mixing a sample in a container using a probe, and apparatus and methods incorporating the same. In embodiments, the mixing occurs when a probe of the apparatus comes in contact with the sample. The probe comprises an elongate probe body and a mixing device, and an actuator is operable to reciprocate the probe in the container along the probe axis such that the mixing device generates mixing currents in the sample. In particular, embodiments of the technology may be used in laboratory liquid handling systems. Laboratory liquid handling systems are used to transport and operate on volumes of liquid. For example, in such an embodiment where the sample is a liquid, one or more liquid samples may be provided in sample containers (e.g., microwell plates, tubes, or vials) in a liquid handling system. As such, disclosed is a probe for mixing, and apparatus, methods, and systems for using the same.

The probe may be a pipettor that is used to remove (e.g., by aspirating) a portion of a sample from a container and/or to add (e.g., by dispensing) material into the container (e.g., to add a sample to the container or to add material to a sample in the container). The probe agitates or mixes the sample in the container. In some embodiments, the mixing is executed robotically and, in some cases, automatically and programmatically. In some embodiments, other liquid handling steps such as aspirating, dispensing, moving, or heating the sample are also executed robotically and, in some cases, automatically and programmatically.

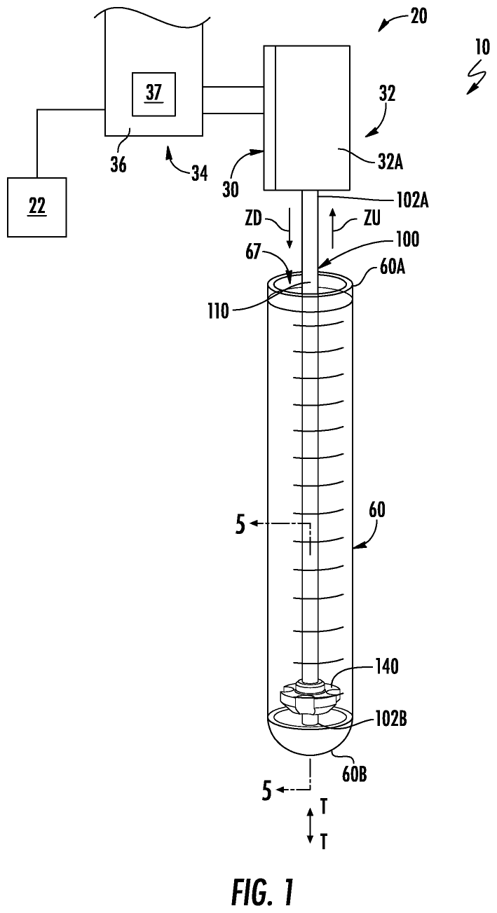

With reference to FIGS. 1-6, a liquid handling probe 100 according to embodiments of the technology and a liquid handling system 10 according to embodiments of the technology are shown therein. The liquid handling system 10 includes the probe 100 and a liquid handling apparatus 20. The liquid handling probe 100 and the liquid handling system 10 may be used with one or more sample containers 60 each containing a sample 15 or available to receive a sample 15.

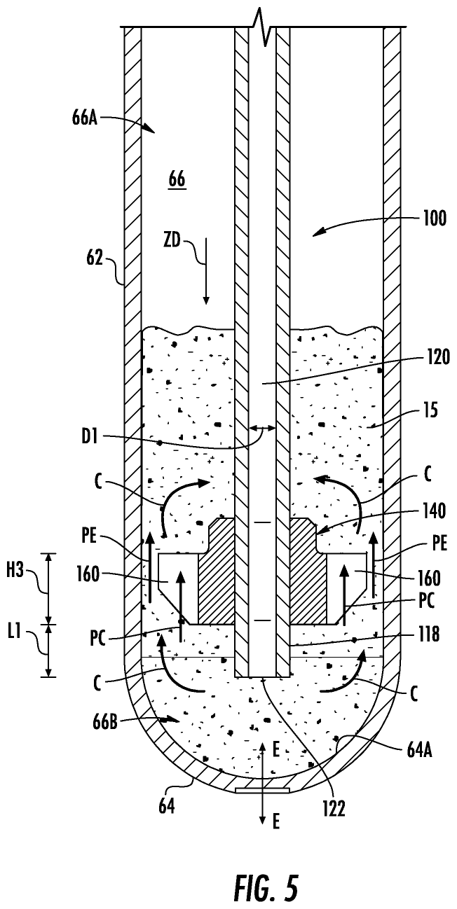

An exemplary sample container 60 is shown in FIGS. 1 and 5. The sample container 60 has a sample container axis T-T. The sample container 60 has a top end 60A and an opposing bottom end 60B spaced apart along the container axis T-T. In some embodiments, the sample container 60 is a cylindrical vial as shown. The sample container 60 includes a sidewall 62 and an integral bottom end wall 64 at the bottom end 60B. The walls 62, 64 define a containment chamber 66 terminating at an inlet opening 67 at the top end 60A.

In some embodiments, the containment chamber 66 has an upper cylindrical section 66A and a lower tapered section 66B. In some embodiments and as shown, the tapered section 66B is defined by an arcuate inner surface 64A of the bottom end wall 64. In some embodiments and as shown, the inner surface 64A has a substantially semi-spherical shape.

The container 60 may be formed of any suitable material(s). In some embodiments, the container 60 is formed of a material such as steel, polymer or glass, although the present disclosure is not limited the sample container material, or any other aspect of the sample container (e.g., shape, size, volume, capacity, etc.).

In some embodiments, the chamber 66 has a volume in the range of from about 5 ml to 100 ml.

While an elongate vial is shown and described for the sample container 60, sample containers of other configurations and constructions may be used. For example, the sample container may be a well plate or portion thereof, and the containment chamber may be a well.

The liquid handling apparatus 20 may be any suitable apparatus that can aspirate and/or dispense a desired amount of a liquid from or into a container. The liquid handling apparatus 20 includes a probe head 30, a liquid transfer system 32, a probe positioning system 34, and a controller 22. The probe 100 is mounted on the probe head 30 for movement therewith.

The liquid transfer system 32 may include a liquid transfer actuator 32A. The liquid transfer actuator 32A may be, for example, a syringe or pump fluidly connected to the probe 100 directly or by one or more lengths of tubing. The liquid transfer system 32 may be controlled by the controller 22.

The probe positioning system 34 may include one or more actuators operable to position the probe relative to the container 60. For example, the probe positioning system 34 may include a robotic mechanism operable to move the probe head 30 about an analytical instrument deck. The probe positioning system 34 includes a probe displacement mechanism 36. The probe displacement mechanism 36 includes a probe displacement actuator 37. The probe displacement mechanism 36 and the probe displacement actuator 37 are operable to move, displace or translate the probe 100 in each of an upward axial displacement direction ZU and an opposing downward axial displacement direction ZD. The probe positioning system 34 may be controlled by the controller 22.

The probe displacement actuator 37 may be any suitable type of actuator. In some embodiments the probe displacement actuator 37 is an electric motor or solenoid.

The controller 22 may be any suitable device or devices for providing the functionality described herein. The controller 22 may include a plurality of discrete controllers that cooperate and/or independently execute the functions described herein. The controller 22 may include a microprocessor-based computer.

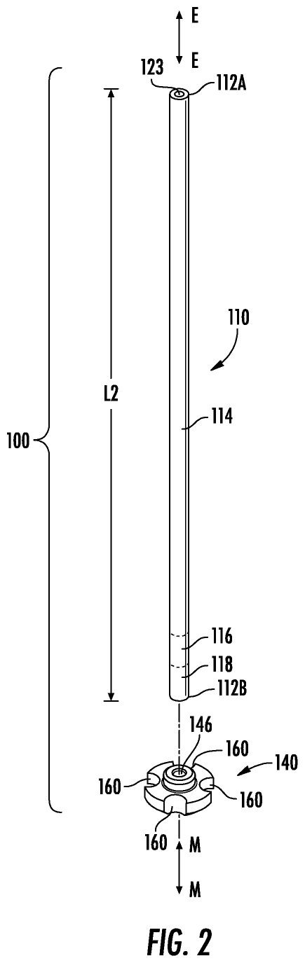

With reference to FIG. 2, the probe 100 includes an elongate probe body 110 and an integral mixing device 140. The probe 100 has a probe longitudinal axis E-E. The probe 100 extends from a proximal end 102A to an opposing distal end 102B.

The probe body 110 is an elongate, rigid or semi-rigid conduit or shaft. The probe body 110 has a proximal end 112A and an opposing distal end 112B. The ends 112A and 112B may be coincident with the ends 102A and 102B.

With reference to FIG. 5, an elongate through passage or probe lumen 120 extends axially through the probe body 110 from a proximal terminal opening, orifice or port 123 (FIG. 2) at the proximal end 112A to a distal terminal opening, orifice or port 122 at the distal end 112B. In some embodiments, the lumen 120 extends fully and continuously from the port 123 to the port 122. In some embodiments, the lumen 120 is in fluid communication with and terminates at each of the ports 122 and 123. The port 122 may serve as an inlet or an outlet, as discussed below. The lumen 120 and port 122 may each have any suitable shape or geometry (e.g., rectangular, elliptical, circular, or square).

With reference to FIG. 2, the probe body 110 includes an upper section 114, a coupling section 116, and a tip section 118. The upper section 114 extends downwardly from the proximal end 112A. The tip section 118 extends upwardly from the distal end 112B. The coupling section 116 extends between the upper section 114 and the tip section 118. The probe body 110 may have any cross-sectional shape or geometry (e.g., rectangular, elliptical, circular, or square). In some embodiments, the probe body 110 is cylindrical as shown. In some embodiments, the probe body 110 tapers inwardly in the direction of the distal end 112B.

The probe body 110 may be formed of any suitable material. According to embodiments, the probe body 110 is formed of a polymeric material. In some embodiments, the probe body 110 is formed of a metal (e.g., stainless steel). In some embodiments, the probe body 110 is formed of carbon fiber composite. Such examples are provided for illustration and not limitation, as the present disclosure is not limited to the material, size, and/or dimensions of the probe body 110.

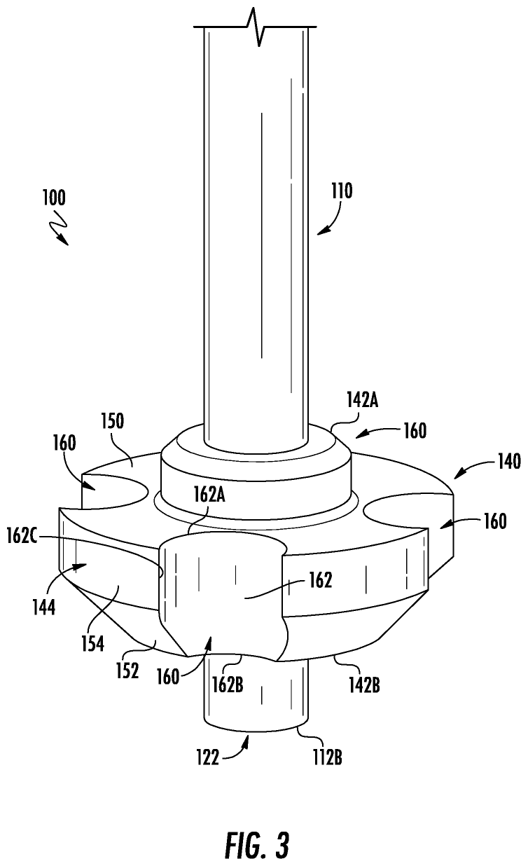

The mixing device 140 is mounted on the probe body 110. The mixing device 140 has a central axis M-M. With reference to FIG. 3, the mixing device 140 has an upper end 142A and an opposing lower end 142B.

The mixing device 140 includes a mixing device body 144. The mixing device body 144 may be generally cylindrical and includes a top surface 150 (at the upper end 142A), a bottom surface 152 (at the lower end 142B), and a side surface 154 extending circumferentially and axially between the upper end 142A and the lower end 142B. A central through bore 146 (FIG. 2) is defined in the mixing device body 144 and extends along the axis M-M.

With reference to FIG. 3, in some embodiments, the bottom surface 152 is rounded or convex. In some embodiments, the bottom surface 152 has a conical, frustoconical or domed shape or profile (e.g., as shown).

Recess surfaces 162 define a plurality (as shown, four) of flow channels 160. Each flow channel 160 defines a top channel opening 162A, a bottom channel opening 162B, and a side channel opening 162C.

The flow channels 160 extends radially inwardly from the side surface 154 and are circumferentially spaced part from one another about the central axis M-M. In some embodiments, the flow channels 160 are equidistantly circumferentially spaced part. While four flow channels 160 are shown, in other embodiments the mixing device 140 may include more or fewer flow channels 160.

The mixing device 140 is mounted on the probe body 110 such that the coupling section 116 (FIG. 2) is received in the central through bore 146. The mixing device 140 may be secured to the coupling section 116 by any suitable technique. In some embodiments, the coupling section 116 is bonded to the mixing device 140 in the through bore 146. For example, the components 140 and 110 may be bonded using adhesive or welding (e.g., sonic welding). In some embodiments, the mixing device 140 is press-fit on the coupling section 116 in the through bore 146.

The mixing device 140 may be formed of any suitable material. According to embodiments, the mixing device 140 is formed of a polymeric material. In some embodiments, the mixing device 140 is formed of a metal. In some embodiments, the mixing device 140 is formed of a carbon fiber composite. In some embodiments, the mixing device 140 is monolithic.

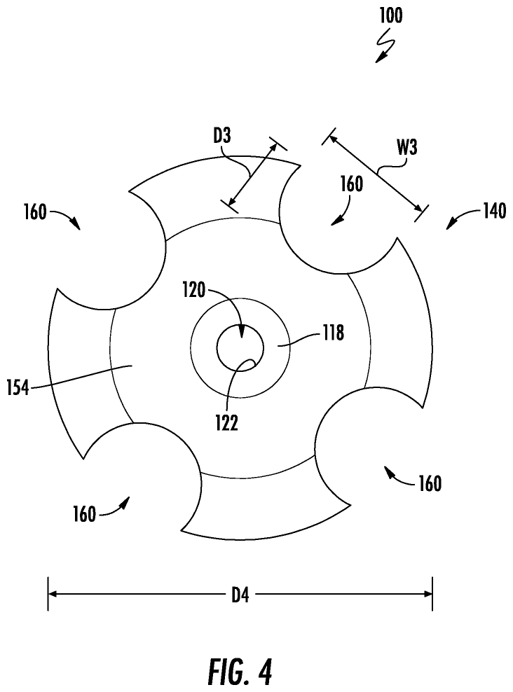

In some embodiments, each flow channel 160 has a channel depth D3 (FIG. 4) in the range of from about 1 mm to 10 mm.

In some embodiments, each flow channel 160 has a height 113 (FIG. 5) in the range of from about 1 mm to 20 mm.

In some embodiments, the channel top and bottom openings 162A, 162B each have a width W3 (FIG. 4) in the range of from about 6 mm to 20 mm.

The tip section 118 extends downwardly from the lower end 142B of the mixing device 140 a length L1 (FIG. 5). In some embodiments, the length L1 is in the range of from about 1 mm to 10 mm and, in some embodiments, in the range of from about 10 mm to 15 mm.

In some embodiments, the length L2 (FIG. 2) of the probe body upper section 114 is in the range of from about 120 mm to 250 mm.

In some embodiments, the probe lumen 120 has an inner diameter D1 (FIG.
5) in the range of from about 1 mm to 10 mm.

In some embodiments, the outer diameter D4 (FIG. 4) of the mixing device 140 is in the range of from about 5 mm to 50 mm.

The probe 100 and system 10 may be used as follows in accordance with some methods of the technology. The distal end 102B of the probe 100 is positioned over and inserted into the containment chamber 66 (FIG. 5) of the sample container 60 through the inlet opening 67. The tip section 118 and the mixing device 140 may be immersed in the sample 15.

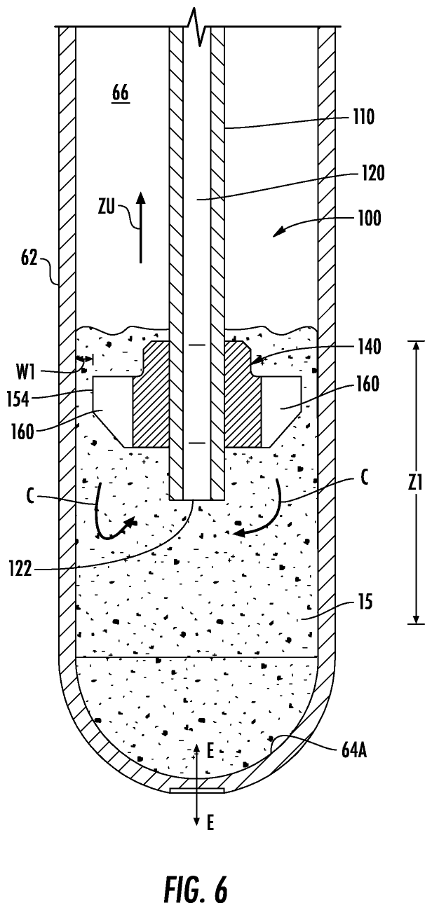

A mixing process is then executed using the liquid handling apparatus 20. More particularly, the probe displacement actuator 37 is then operated to translate or reciprocate the probe 100, and thereby the mixing device 140, in the upward direction ZU and the downward direction ZD along the probe axis E-E (FIG. 5) in the sample 15. The reciprocating movement is illustrated in FIG. 5 (wherein the probe 100 is shown translated down into its lowermost reciprocating position for the illustrated embodiment) and in FIG. 6 (wherein the probe 100 is shown translated up into its uppermost reciprocating position for the illustrated embodiment). It shall be understood that the relative “uppermost” and “lowermost” positions are illustrative and not limiting, as such may vary depending on container characteristics (e.g., size, shape, etc.), sample content, desired mixing results, etc.

With reference to FIG. 5, as the mixing device 140 is displaced or translated up and down, the mixing device 140 displaces the sample 15. The mixing device 140 generates sample flow currents C in the chamber 66. Some of the sample flow currents C follow paths PC (FIG. 5) through the channels 160. Some of the sample flow currents may follow paths PE (FIG. 5) around the mixing device 140 between the container sidewall 62 and the outer side surface 154.

In this manner, the probe 100 churns or mixes the sample 15 in the containment chamber 66. The probe 100 may be reciprocated as desired to render the sample substantially homogenous, for example. In some embodiments, the mixing process mixes solids within the sample with liquid of the sample.

In some embodiments, the probe 100 is driven in each direction ZU and ZD multiple times. In some embodiments, the probe 100 may be driven in each direction ZU and ZD from about 2 to 5 times. In some embodiments, the probe 100 may be driven in each direction ZU and ZD only once. The present disclosure is not limited by or to the number of times that the probe 100 may be driven in the ZU or ZD directions, as such may vary depending on the sample characteristics and other user-defined specifications.

In some embodiments, the stroke distance Z1 (FIG. 6) between the lowermost position of the mixing device 140 (e.g., FIG. 5) and the uppermost position of the mixing device 140 (e.g., FIG. 6) is at least 20 mm and, in some embodiments, is in the range of from about 5 mm to 100 mm, although other values of Z1 may be used based on the sample container 60 characteristics and/or sample quantity, for example.

In some embodiments, the radial spacing clearance W1 (FIG. 6) between the side wall 62 of the sample container 60 and the outer periphery (e.g., on side surface 154) of the mixing device 140 is in the range of from about 0.5 mm to 2 mm, although such measurements are illustrative only and may be user-defined based on the sampler container 60 and sample characteristics, for example. It can be understood that the radial spacing clearance (W1) can be tailored for formation of appropriate mixing currents or turbulence to allow for desirable agitation of the sample container contents.

In addition to mixing the sample 15, the probe 100 can be used to transfer liquid to and/or from the sample container 60 through the lumen 120 in accordance with some methods of the technology.

In some embodiments, a portion of the sample 15 is siphoned, withdrawn or aspirated from the containment chamber 66 through the port 122 and the lumen 120 after the mixing process. In some embodiments, a portion of the sample 15 may be withdrawn or aspirated from the containment chamber 66 (through the port 122 and the lumen 120) within about 60 to 120 seconds after the mixing process. In some embodiments, a portion of the sample 15 may be withdrawn or aspirated from the containment chamber 66 (through the port 122 and the lumen 120) without first removing the probe 100 from the sample container 60.

In some embodiments, a portion of the sample 15 may be withdrawn or aspirated from the containment chamber 66 through the port 122 and the lumen 120 prior to the mixing process.

In some embodiments, the sample 15 and/or another liquid may be dispensed into the chamber 66 through the port 122 and the lumen 120 before the mixing process.

In some embodiments, the sample 15 and/or another liquid may be dispensed into the chamber 66 through the port 122 and the lumen 120 after the mixing process.

The system 10 and probe 100 may be used to execute any desired combination and sequence of withdrawing liquid from the sample container 60 and dispensing liquid into the sample container 60 through the lumen 120, and with any desired number of repetitions. In some embodiments, the sample 15 or another liquid is withdrawn from the sample container 60 or dispensed into the container 60 without removing the mixing device 140 from the sample container 60 between mixing the sample 15 and withdrawing or dispensing the illustrative liquid sample 15.

The rounded shape of the bottom surface 152 of the mixing device 140 can provide clearance with the rounded bottom or arcuate inner surface 64A of the sample container 60. This may enable the probe 100 to be inserted closer to the bottom of the sample container 60 to facilitate mixing or aspiration of the sample at the bottom of the sample container 60.

Because the tip section 118 extends axially below the mixing device 140, the port 122 can be positioned at or nearer the bottom wall of the tapered-bottomed of the sample container 60 without causing interference between the mixing device 140 and the sample container 60. This can enable the system 10 to more reliably and effectively aspirate liquid from the very bottom of the containment chamber 66.

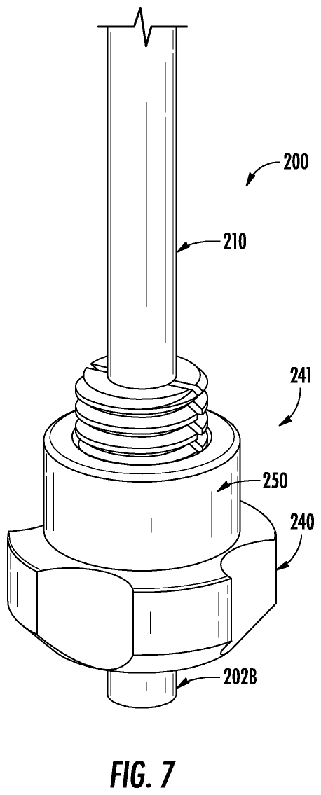

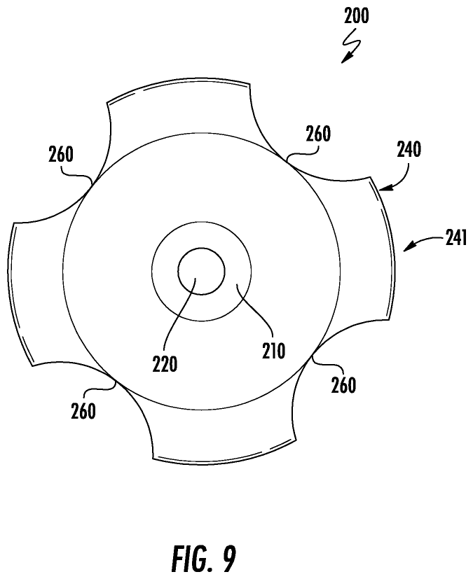

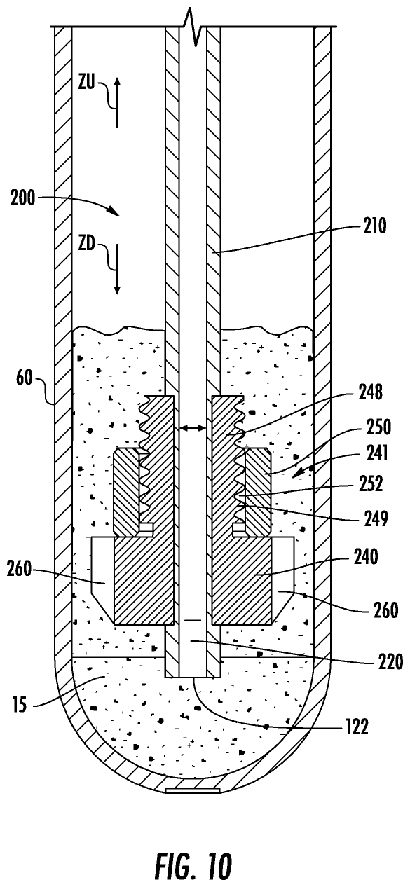

With reference to FIGS. 7-10, a probe 200 according to further embodiments of the technology is shown therein. The probe 200 may be used in place of the probe 100, for example. The probe 200 includes a probe body 210, a probe lumen 220, and a port 222 corresponding to the probe body 110, the lumen 120, and the port 122. The probe 200 also includes a mixing device assembly 241.

The probe 200 is used and operated in the same manner as the probe 100 (i.e., by translating or reciprocating the probe 200 in axial directions ZD, ZU) to mix the liquid 15 in the sample container 60.

The mixing device assembly 241 includes a mixing device 240 and a nut 250. The nut 250 has an inner screw thread 252.

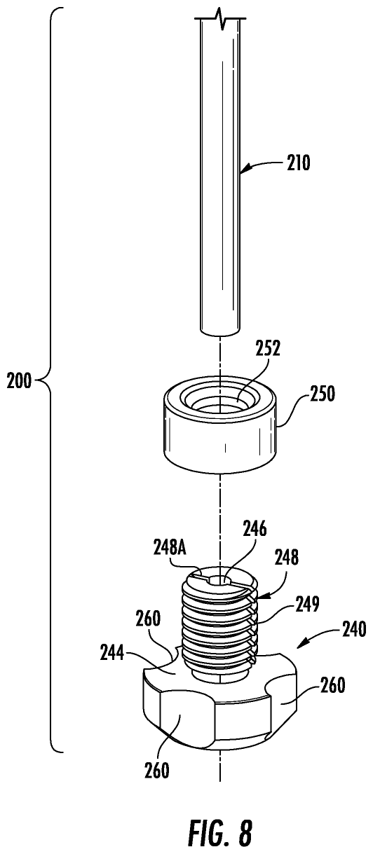

With reference to FIG. 8, the mixing device 240 generally corresponds to the mixing device 140. The mixing device 240 includes a body 244, a central bore 246, and radial flow channels 260 corresponding to the body 144, the central bore 146, and the flow channels 160 (e.g., FIGS. 3 and 4). The mixing device 240 further includes a collar 248 having a lateral split 248A and an outer screw thread 249.

The mixing device assembly 241 is secured to the probe body 210 proximate the distal end 202B in the same location and manner as described for the mixing device 140, except that the mixing device assembly 241 is clamped onto the probe body 210 by tightening the nut 250 onto the collar 248.

In some embodiments, the mixing device assembly 241 can be installed on and/or removed from the probe body 210 as desired. In some embodiments, the mixing device assembly 241 is retrofitted onto an existing probe body. For example, the mixing device assembly 241 can be installed by an end user on a probe as desired in a location of use (e.g., and a laboratory) other than the site of manufacture.

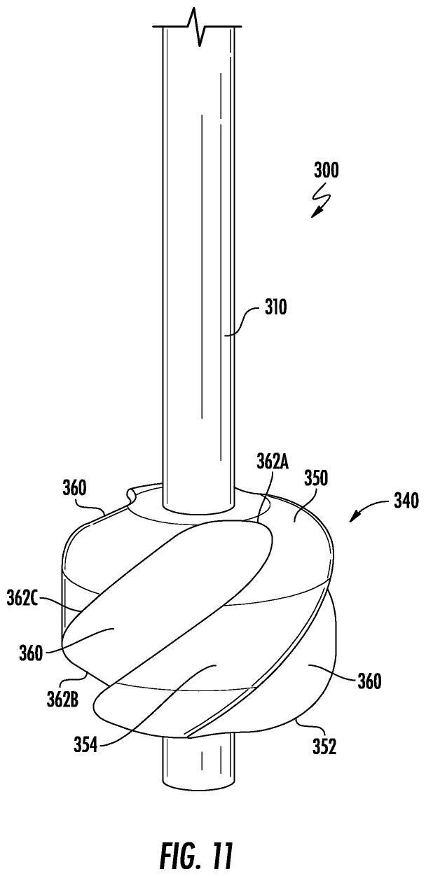

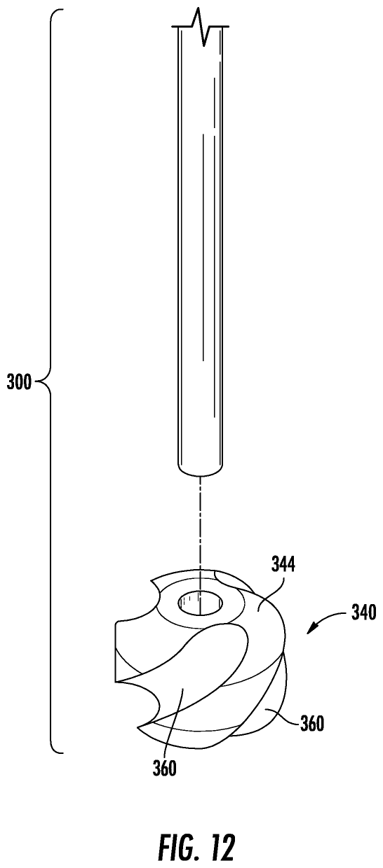

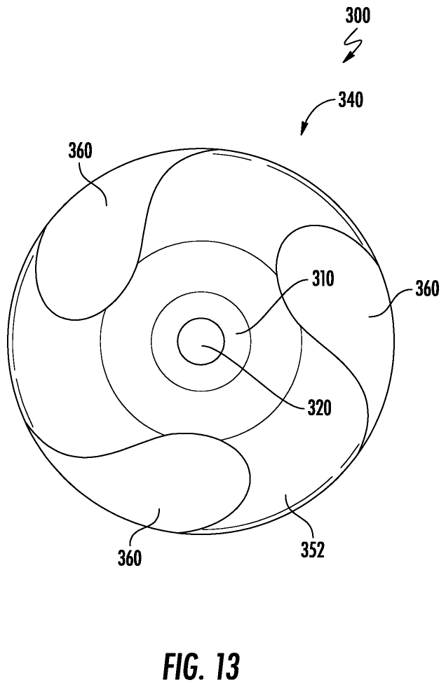

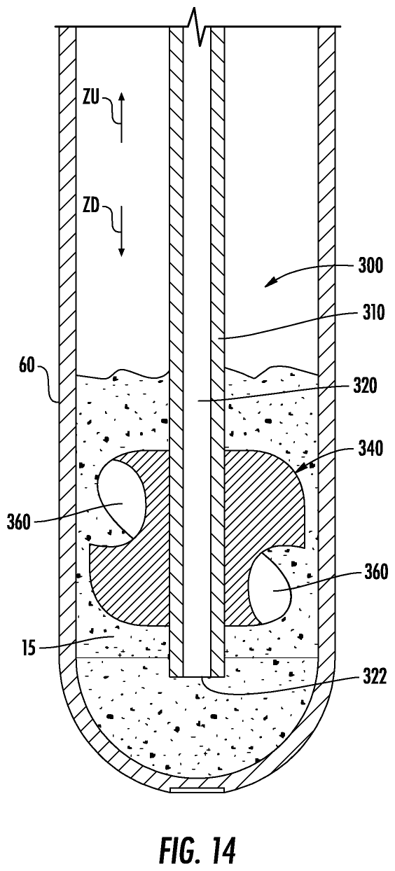

With reference to FIGS. 11-14, a probe 300 according to further embodiments of the technology is shown therein. The probe 300 may be used in place of the probe 100 and in the same manner, for example. The probe 300 includes a probe body 310, a probe lumen 320, a port 322, and a mixing device 340 corresponding to the probe body 110 (FIG. 2), the lumen 120 (FIG. 4), the port 122 (FIG. 3), and the mixing device 140 (FIG. 3).

The probe 300 is used and operated in the same manner as the probe 100 (i.e., by translating or reciprocating the probe 300 in axial directions ZD, ZU) to mix the liquid 15 in the sample container 60.

The mixing device 340 includes a mixing device body 344 corresponding to the mixing device body 144. The mixing device 340 differs from the mixing device 140 helical flutes or flow channels 360 are defined in the sidewall 354 of the device body 344. The flow channels 360 of the illustrated embodiment extend from the upper shoulder 350 to the lower shoulder 352 of the device body 344. Like the flow channels 160 (e.g., FIGS. 2-4), the flow channels 360 each can be understood as having a top opening 362A, a bottom opening 362B, and a side opening 362C.

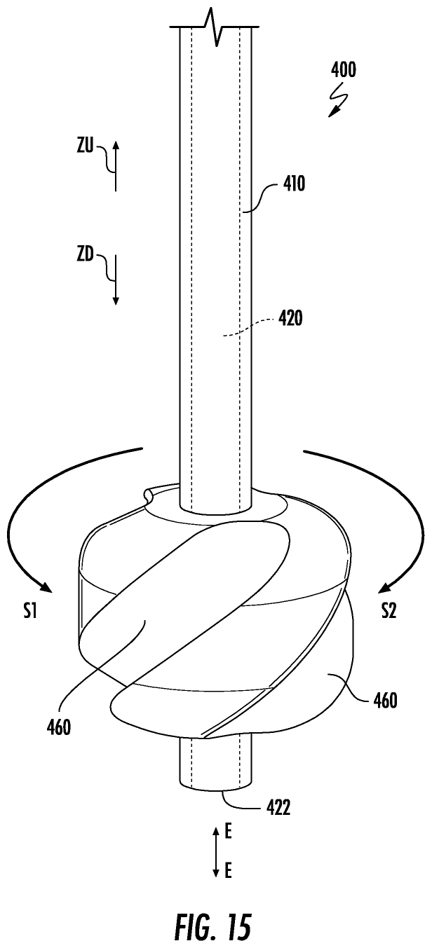

With reference to FIG. 15, a probe 400 according to further embodiments of the technology is shown therein. The probe 400 may be used in place of the probe 100 and in the same manner, for example. The probe 400 includes a probe body 410, a probe lumen 420, a port 422, and a mixing device 440 corresponding to the probe body 310, the lumen 320, the port 322, and the mixing device 340.

The probe 400 differs from the probe 300 in that the mixing device 440 is mounted to enable the mixing device 440 to rotate or spin about the axis E-E relative to the probe body 410.

In use, when the probe body 410 is axially displaced or translated by the displacement mechanism 36 along the axis E-E, the shapes of the channels 460 cause the mixing device 440 to rotate in opposed spin directions S1, S2 about the probe axis E-E (and, in some embodiments, about the probe body 410). That is, the translational movement of the mixing device 440 (in axial directions ZU, ZD) is converted to spin movement of the mixing device 440 by the shape of the mixing device 440. This spin motion may assist in mixing the sample 15.

The probe 400 can be used to withdraw or dispense fluid through the probe lumen 420 and port 422 in the same ways as discussed above (e.g., before and/or after mixing the sample using the probe 400).

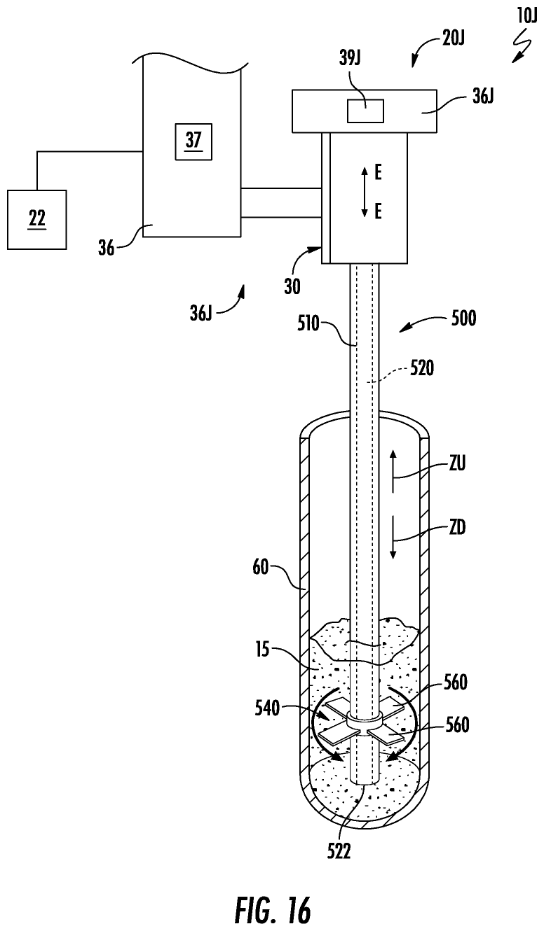

With reference to FIG. 16, a liquid handling system 10J according to further embodiments of the technology is shown therein. The system 10J may be used in the same manner as the liquid handling system 10, except as discussed below.

The liquid handling system 10J includes a probe 500 and a liquid handling apparatus 20J. The liquid handling apparatus 20J includes a probe head 30, a liquid transfer system 32, a probe positioning system 34J, and a controller 22 corresponding to the components 30, 32, 34 and 22, respectively, of the system 10 (e.g., FIG. 1). The probe positioning system 34J includes a mixing device rotary displacement mechanism 36J. The mixing device rotary displacement mechanism 36J includes a rotary displacement actuator 39J.

The probe 500 may be constructed in the same manner as the probe 100 and includes a probe lumen 520 and a port 522 corresponding to the lumen 520 and the port 522. In the illustrated probe 500, the mixing device 540 thereof is differently configured than the mixing device 140 and has a plurality of wings or vanes 560 that form a propeller. However, other configurations may be employed.

The liquid handling apparatus 20J differs from the apparatus 20 in that the mixing device rotary displacement mechanism 36J is operable to rotate or spin the mixing device 540 about the probe longitudinal axis E-E. In some embodiments, the mixing device 540 is forcibly rotated or spun about the axis E-E by a spin actuator 39J forming a part of the rotary displacement mechanism 36J. In some embodiments, the mixing device 540 is spun by rotating the mixing device 540 independently of the probe body 510. In some embodiments, the mixing device 540 is affixed to the probe body 510 for rotation therewith, and the mixing device 540 is spun by rotating the probe body 510.

The spin actuator 39J may be any suitable type of actuator. In some embodiments the spin actuator 39J is an electric motor (e.g., a rotary electric motor).

In use, the probe 500 is inserted into the sample in the containment chamber 66 as described above. The mixing device 540 is then forcibly spun by the displacement mechanism 36J in the sample 15 in the containment chamber 66 as described to mix the sample 15.

In some embodiments, the probe positioning system 34J also axially displaces, translates or reciprocates the mixing device 540 in opposing up and down axial directions ZU, ZD (as described above with regard to the probe 100) while forcibly spinning the mixing device 540. The probe positioning system 34J may include a probe axial displacement mechanism 36 (including an axial displacement actuator 37) that is constructed and operates as described above with reference to the mechanism 36 and actuator 37 of FIG. 1.

The probe 500 can be used to withdraw or dispense fluid through the probe lumen 520 and port 522 in the same ways as discussed above with regard to the lumen 120 and port 122 (e.g., before and/or after mixing the sample using the probe 500).

Some probes according to embodiments of the technology may be configured without a lumen and a port corresponding to the lumen 120 and the port 122. For example, any of the probes 100-500 could be formed without a lumen and serve only as a mixing probe, not a probe capable of both mixing and fluid transport.

Mixing devices according to embodiments of the technology can have any suitable shape or geometry (e.g., rectangular, square, spherical, cylindrical, round, elliptical, or other).

While certain numbers and shapes of mixing surfaces and channels (e.g., 160, 260, 360) on mixing devices have been shown and described, other numbers and shapes of channels, scallops, recesses, and flutes may be used in the mixing devices according to embodiments of the technology.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

The term “automatically” means that the operation is substantially, and may be entirely, carried out without human or manual input, and can be programmatically directed or carried out.

The term “programmatically” refers to operations directed and/or primarily carried out electronically by computer program modules, code and/or instructions.

The term “electronically” includes both wireless and wired connections between components.

The term “monolithic” means an object that is a single, unitary piece formed or composed of a material without joints or seams.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A liquid handling system for use with a liquid sample in a container, the liquid handling system comprising:
a probe configured to be inserted into the container to contact the liquid sample in the container, the probe having a probe axis and comprising:
an elongate probe body having a distal end; and
an integral mixing device on the probe body proximate the distal end; and
an actuator operable to reciprocate the probe in the container along the probe axis such that the mixing device generates mixing currents in the liquid sample.

2. The liquid handling system of claim 1 wherein the mixing device comprises:
a mixing device body; and
at least one flow channel defined in the mixing device body;
wherein said reciprocation of the probe in the container along the probe axis generates a mixing current flow of the liquid sample through the at least one flow channel.

3. The liquid handling system of claim 2 wherein the at least one flow channel comprises a plurality of flow channels spaced circumferentially about the mixing device body.

4.-8. (canceled)

9. The liquid handling system of claim 1 wherein the mixing device is mounted on the probe body such that reciprocation of the probe in the liquid sample causes the mixing device to rotate.

10. The liquid handling system of claim 1 wherein the probe body comprises a probe lumen extending therethrough.

11. The liquid handling system of claim 10 wherein the probe body comprises a distal end port at the distal end and fluidly communicating with the probe lumen.

12. The liquid handling system of claim 11 wherein the probe body comprises a tip section that extends between a lower end of the mixing device and the distal end port.

13. The liquid handling system of claim 10 comprising a liquid transfer actuator fluidly connected to the probe lumen and operable to withdraw fluid from the container through the probe lumen and/or to dispense fluid into the container through the probe lumen.

14. A method for mixing a liquid sample in a container in a liquid handling system, the method comprising:
inserting a probe into the container and into contact with the liquid sample in the container, the probe having a probe axis and comprising:
an elongate probe body having a distal end; and
an integral mixing device on the probe body proximate the distal end; and
reciprocating the probe in the container along the probe axis using an actuator such that the mixing device generates mixing currents in the liquid sample.

15. A probe for use in a liquid handling system for use with a liquid sample in a container, the probe having a probe axis and comprising:
an elongate probe body having a distal end;
a probe lumen extending through the probe body; and
an integral mixing device on the probe body proximate the distal end.

16. The probe of claim 15 wherein the mixing device comprises:
a mixing device body; and
at least one flow channel defined in the mixing device body;
wherein the probe is configured such that the mixing device generates a mixing current flow of the liquid sample through the at least one flow channel when the probe is reciprocated in the container along the probe axis.

17. The probe of claim 16 wherein the at least one flow channel comprises a plurality of flow channels spaced circumferentially about the mixing device body.

18.-22. (canceled)

23. The probe of claim 15 wherein the mixing device is mounted on the probe body such that reciprocation of the probe in the liquid sample causes the mixing device to rotate.

24. The probe of claim 15 wherein the probe body comprises a distal end port at the distal end and fluidly communicating with the probe lumen.

25. The probe of claim 24 wherein the probe body comprises a tip section that extends between a lower end of the mixing device and the distal end port.

26.-38. (canceled)

39. A method for mixing a liquid sample in a container in a liquid handling system, the method comprising:
inserting a probe into the container and into contact with the liquid sample in the container, the probe having a probe axis and comprising:
an elongate probe body having a distal end;
a probe lumen extending through the probe body; and
an integral mixing device on the probe body proximate the distal end; and
displacing the probe in the container using an actuator such that the mixing device generates mixing currents in the liquid sample.

40. The method of claim 39 including withdrawing the liquid sample from the container through the probe lumen.

41. The method of claim 39 including dispensing the liquid sample or another liquid into the container through the probe lumen.
